(19) United States
(12) Patent Application Publication
(10) Pub. No.: US 2007/0160292 A1
(43) Pub. Date: Jul. 12, 2007

(54) Method of inputting chinese characters

(76) Inventor: Jung-Tai Wu, Tainan City (TW)

Correspondence Address: ANDREWS KURTH LLP, 1350 I STREET, N.W., SUITE 1100, WASHINGTON, DC, 20005, US

(21) Appl. No.: 11/326,454

(22) Filed: Jan. 6, 2006

(51) Int. Cl. G06K 9/00

(52) U.S. Cl. 382/181

(57) ABSTRACT

A Chinese character input method includes defining corners of a character, wherein the corners and sequence of input includes an upper left corner; an upper right corner, a lower left corner and a lower right corner, determining shapes of each of the corners of the character based on extension of a first stroke of each corner to locate an intersection and/or a turn, wherein should there be no intersection and/or turn, the extension of the first stroke of each corner is defined as a line segment and establishing a databank consisting of intersections, turns, line segments and exceptional codes to correspond to geometrical shapes of the corners such that according to the input sequence, different shapes from different corners are combined to map with a corresponding character in the databank.

### BACKGROUND OF THE INVENTION

1. Field of the Invention

The present invention relates to a method of inputting Chinese characters, and more particularly to a method defining different shapes from corners of a Chinese character and regulating the sequence of inputting corner shapes to combine the shapes into a full Chinese character.

2. Description of the Related Art

Nowadays, the mainstream of Chinese character input is divided into two categories: the phonetic input method and the dismantling input method. The phonetic input method requires less technique for users, so users of this type of input may easily grasp the key steps. However, because the possibility of word repetition is so high, the user has to choose the correct word from a data bank, which slows down the user's input speed. The dismantling input method requires the user to memorize a lot of character roots and then the input sequences of the different character roots so as to form a complete Chinese character. This type of input requires a more advanced technique from the users, thus taking a much longer time to master than the phonetic input method. However, due to the fact that the word repetition possibility is low, the user's input speed is much higher than those who adopt the phonetic input method after the dismantling input users become familiar with the input rules.

Because Chinese characters are taught from the elementary school level, both input methods are quite easy to learn for Chinese people. To those who are not taught in Chinese or familiar with Chinese characters, using all kinds of different modern electronic devices such as PDAs (personal digital assistants), laptop computers or electronic dictionaries to communicate with Chinese people does not come easy. All people using the electronic devices need to know the basic input steps as well. Therefore, people not familiar with Chinese characters often feel frustrated because there is no input method available for them to use the hand-held electronic devices to communicate with Chinese people, especially in writing.

To overcome the shortcomings, the present invention provides an input method to mitigate the aforementioned problems.

### SUMMARY OF THE INVENTION

The primary objective of the present invention is to provide an input method available for people who are not familiar with Chinese characters.

The method of the present invention provides an inputting method comprising the steps of:

defining corners of a character;

determining shapes of each of the corners of the character; and

establishing a databank to correspond to the geometrical shapes of the corners.

Other objectives, advantages and novel features of the invention will become more apparent from the following detailed description when taken in conjunction with the accompanying drawings.

### BRIEF DESCRIPTION OF THE DRAWINGS

FIG. 1 is a function diagram showing the process of the method of the present invention;

FIG. 2 is the first embodiment showing the character dismantling method of the present invention;

FIG. 3 is the second embodiment showing the character dismantling method of the present invention;

FIG. 4 is the third embodiment showing the character dismantling method of the present invention;

FIG. 5 is the fourth embodiment showing the character dismantling method of the present invention;

FIG. 6 is the fifth embodiment showing the character dismantling method of the present invention; and

FIG. 7 is an embodiment showing that different symbols representing the same character are possible based on how the character is formed.

### DETAILED DESCRIPTION OF THE PREFERRED EMBODIMENT

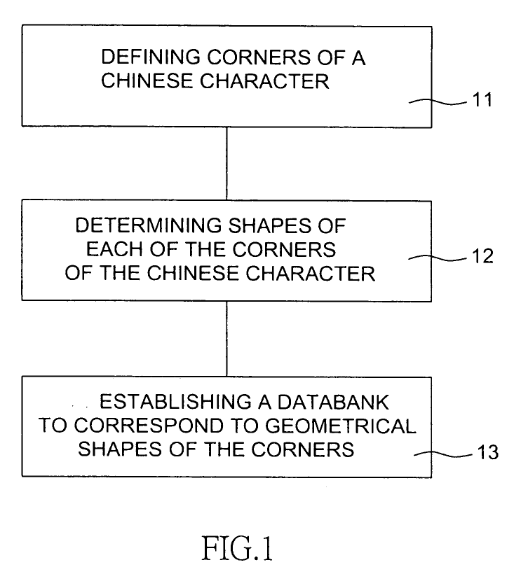

With reference to FIG. 1, it is noted that the Chinese character inputting method of the present invention is a mapping process that uses simple geometrical combinations of corners of a Chinese character to correspond to a built-in Chinese character stored in a Chinese character databank. After the mapping process is finished, the corresponding Chinese character in the databank will then pop up on the screen. The method includes the following steps:

defining corners of a Chinese character (11);

determining shapes of each of the corners of the Chinese character (12); and

establishing a databank to correspond to geometrical shapes of the corners (13).

In the first step of determining corners of a Chinese character (11), the principle is to use the feature that most Chinese characters are formed into a square so that a Chinese character is divided into corners including an upper left corner, upper right corner, lower left corner, and lower right corner and a sequence of selecting the corners is thus determined.

In the second step of determining the shapes of each of the corners of the character (13), the method of shape determination is based on a first stroke of a specific corner as a starting point. Along an extension of the first stroke of that corner, a first intersection or a turn with another stroke of that corner is to be located, wherein when there is no turn or intersection with other stroke, the first stroke is then determined as a line segment to facilitate identification of the shape of this corner.

In the step of establishing a databank to correspond to geometrical shapes of the corners (13), a databank composed of different geometrical combination such as a cross, turn, line segment and exceptions is formed and saved in an electronic device to correspond to a specific key on the keyboard of an electronic device. Therefore, a user not familiar with Chinese characters is able to imitate the shape of the corners of a Chinese character to be inputted via the keyboard and inputs the corners of the character according to the input sequence. Thus, a Chinese character is formed after the inputted corners map with a corresponding one of the Chinese character databank in the electronic device.

The previously described turn occurring at the corners of a Chinese character is related to an acute angle, obtuse angle, right angle and central angle. After a stroke of a Chinese character corner passes through any one of the previously described turns, the stroke will be treated as another line segment.

The corner input sequence is determined that the upper left corner shall be the first, the upper right corner shall be the second, the lower left corner shall be the third and the lower right corner shall be the fourth to be selected.

The previously described “line segment” includes the following forms:
1. “-”: which is a horizontal segment and does not intersect with any other line segment, such as the upper strokes in the Chinese character [symbol] and the lower stroke in the Chinese character [symbol]
2. “|”: which is a vertical line segment and does not intersect with any other line segment, such as the left straight line stroke in the character [symbol]
3. “\”: which is an inclined line segment from upper left to lower right and does not intersect with any other line segment, such as the upper left portion of the character [symbol]
4. “/”: which is an inclined line segment from upper right to lower left and does not intersect with any other line segment, such as the lower portion of the character [symbol] .

5. [symbol] : which is an angle formed by two line segments and a joint there is at the upper left corner of this geometrical combination, such as the character “□”.
6. [symbol] : which is an angle formed by two line segments and a joint there is at the upper right corner of this geometric combination, such as the upper right portion of the character [symbol] .
7. [symbol] : which is an angle formed by two line segments and a joint there is at the lower left corner of this geometric combination, such as the lower left portion of the character [symbol] .
8. [symbol] : which is an angle formed by two line segments and a joint there is at the lower right corner of this geometric combination, such as the lower right portion of the character [symbol] .
9. “ [symbol] ”: which is an angle formed by two line segments, wherein a joint there is pointing upward, such as the upper portion of the character [symbol] .
10. [symbol] : which is an angle formed by two line segments, wherein a joint there is pointing downward, such as the lower half of the character [symbol] .
11. “<”: which is an angle formed by two line segments, wherein a joint there is pointing to the left, such as the upper left portion of the character [symbol] .
12. “>”: which is an angle formed by two line segments, wherein a joint there is pointing to the left.

The previously described intersection may be divided into the following deformations:
13. [symbol] : which is a horizontal line segment with an upward extension, such as the upper half of the character [symbol] .
14. [symbol] : which is a horizontal line segment with a downward extension, such as the upper half of the character [symbol] .
15. “┤”: which is a vertical line segment with a leftward extension directly to the straight line.
16. “├”: which is a vertical line segment with an rightward extension directly to the straight line, such as the upper portion of the character [symbol] .
17. “Y”: which is a combination of three line segments extending toward different directions from a common joint, such as the left portion of the character [symbol] or [symbol] .
18. “+”: which are two line segments intersecting with each other, wherein at least one of the line segments is a horizontal line segment or a vertical line segment, such as the upper half of the character [symbol] .
19. “X”: which are two line segments intersecting with each other, wherein none of the line segments is horizontal or vertical, such as the upper half of the character [symbol] .
20. “K”: which is a straight line with two line segments extending in different directions from a common joint on the straight line, such as upper left portion of the character [symbol] .
21. [symbol] : which is a combination of at least five line segments extending from a common joint toward different directions, such as the character [symbol] or [symbol] .

Exceptional codes are also built and divided into the followings:
22. “L”: when a sub-character is surrounded by two adjacent sides of a sub-character, the symbol “L” may be adopted and then the sub-character inside the Chinese character may be dismantled according to the corner rules stated above, such as symbols of [symbol] , [symbol] and [symbol]
23. “U”: when a sub-character is surrounded by three adjacent sides of a sub-character, the symbol “U” may be adopted and then the sub-character inside the Chinese character may be dismantled according to the corner rules stated above, such as symbols of “␣” and [symbol] .
24. “D”: when a sub-character is surrounded by four adjacent sides of a sub-character, the symbol “D” may be adopted and then the sub-character inside the Chinese character may be dismantled according to the corner rules stated above, such as symbols of “□” in a Chinese character of [symbol] .
25. “0”: when one of the line segments, turns or intersections of a corner in a character have been used by a previously selected corner or nothing is at the corner, the symbol “0” is used.

Examples showing how the inputting method of the present invention works is explained in the following:

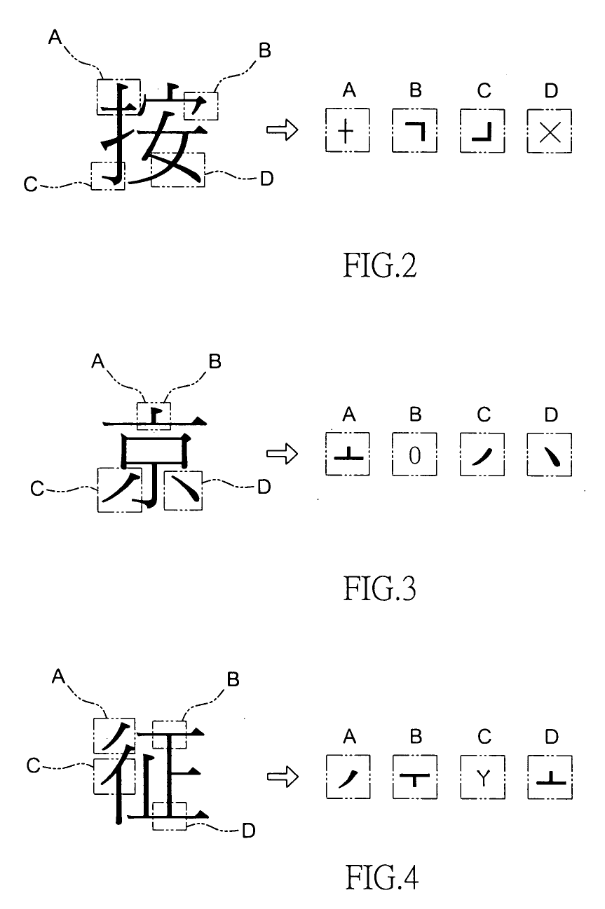

With reference to FIG. 2, when the character [symbol] is to be dismantled so that the user is able to input the dismantled parts into a hand-held electronic device, (A), (B), (C) and (D) respectively representing the upper left corner, the upper right corner, the lower left corner and the lower right corner are defined such that symbols “+”, [symbol] , [symbol] and “X” are sequentially selected and inputted into the electronic device to finish the input of the Chinese character.

With reference to FIG. 3, when the character [symbol] is to be dismantled so that the user is able to input the dismantled parts into a hand-held electronic device, (A), (B), (C) and (D) respectively representing the upper left corner, the upper right corner, the lower left corner and the lower right corner are defined such that symbols [symbol] “0”, “/” and “\” are sequentially selected and inputted into the electronic device to finish the input of the Chinese character.

With reference to FIG. 4, when the character [symbol] is to be dismantled so that the user is able to input the dismantled parts into a hand-held electronic device, (A), (B), (C) and (D) respectively representing the upper left corner, the upper right corner, the lower left corner and the lower right corner are defined such that symbols “/”, [symbol] , “Y” and [symbol] are sequentially selected and inputted into the electronic device to finish the input of the Chinese character.

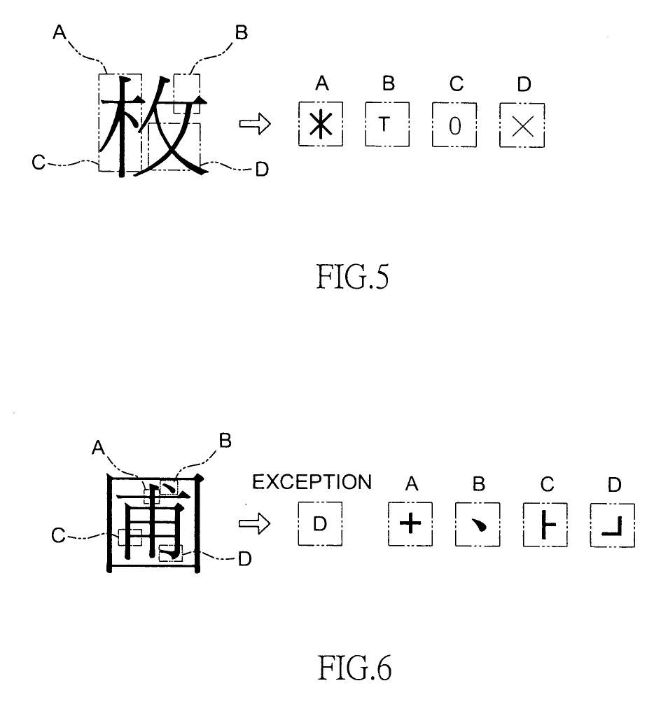

With reference to FIG. 5, when the character [symbol] is to be dismantled so that the user is able to input the dismantled parts into a hand-held electronic device, (A), (B), (C) and (D) respectively representing the upper left corner, the upper right corner, the lower left corner and the lower right corner are defined such that symbols [symbol] , “ [symbol] , “0” and “X” are sequentially selected and inputted into the electronic device to finish the input of the Chinese character.

With reference to FIG. 6, when the character [symbol] is to be dismantled so that the user is able to input the dismantled parts into a hand-held electronic device, (A), (B), (C) and (D) respectively representing the upper left corner, the upper right corner, the lower left corner and the lower right corner are defined such that exceptional code “D” and symbols of [symbol] , 37 \”, [symbol] and [symbol] are sequentially selected and inputted into the electronic device to finish the input of the Chinese character.

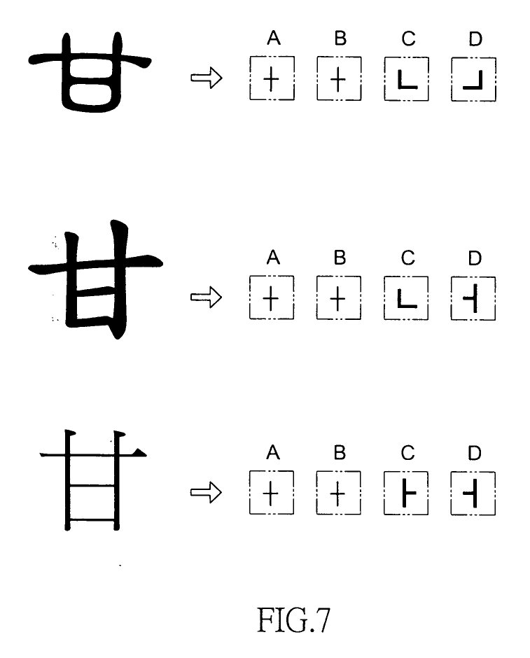

With reference to FIG. 7, it is noted that a single Chinese character has different forms depending on how the character is written so that the same character may have three different forms as shown in the drawing. Thus different symbols such as:

“+”, “+”, [symbol] and [symbol] ;

“+”, “+”, [symbol] and “┤”; and

“+”, “+”, “├” and “┤”, representing each form of the same character are selected.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A Chinese character input method comprising the steps of:
defining corners of a character, wherein the corners and sequence of input includes an upper left corner; an upper right corner, a lower left corner and a lower right corner;
determining shapes of each of the corners of the character based on extension of a first stroke of each corner to locate an intersection and/or a turn, wherein should there be no intersection and/or turn, the extension of the first stroke of each corner is defined as a line segment; and
establishing a databank consisting of intersection, turns, line segments and exceptional codes to correspond to geometrical shapes of the corners such that according to the input sequence, different shapes from different corners are combined to map with a corresponding one of characters in the databank.

2. The method as claimed in claim 1, wherein the shapes of the corners are composed of:
1. “-”: which is a horizontal segment and does not intersect with any other line segment;
2. “|”: which is a vertical line segment and does not intersect with any other line segment;
3. “\”: which is an inclined line segment from upper left to lower right and does not intersect with any other line segment;
4. “/”: which is an inclined line segment from upper right to lower left and does not intersect with any other line segment;
5. [symbol] : which is an angle formed by two line segments and a joint there is at an upper left corner of this geometrical combination;
6. [symbol] : which is an angle formed by two line segments and a joint there is at an upper right corner of this geometric combination;
7. [symbol] : which is an angle formed by two line segments and a joint there is at a lower left corner of this geometric combination;
8. [symbol] : which is an angle formed by two line segments and a joint there is at a lower right corner of this geometric combination;
9. “ [symbol] ”: which is an angle formed by two line segments, wherein a joint there is pointing upward;
10. [symbol] : which is an angle formed by two line segments, wherein a joint there is pointing downward;
11. “<”: which is an angle formed by two line segments, wherein a joint there is pointing to the left;
12. “>”: which is an angle formed by two line segments, wherein a joint there is pointing to the right;
13. [symbol] : which is a horizontal line segment with an upward extension directly from a top face of the line segment;
14. [symbol] : which is a horizontal line segment with a downward extension from a bottom face of the line segment;
15. “┤”: which is a vertical line segment with a leftward extension directly to a left of the line segment;
16. “├”: which is a vertical line segment with an rightward extension directly to a right of the vertical line;
17. “Y”: which is a combination of three line segments extending toward different directions from a common joint;
18. “+”: which is two line segments intersecting with each other, wherein at least one of the line segments is a horizontal line segment or a vertical line segment;
19. “X”: which is two line segments intersecting with each other, wherein none of the line segments is a horizontal or vertical line segment;
20. “K”: which is a line with two line segments extending in different directions from a common joint on the line;
21. “*”: which is a combination of at least five line segments extending from a common joint toward different directions;
22. “L”: when a sub-character is surrounded by two adjacent sides of a sub-character, the symbol “L” is adopted and then the sub-character inside the Chinese character is dismantled according to the corner input sequence;
23. “U”: when a sub-character is surrounded by three adjacent sides of a sub-character, the symbol “U” is adopted and then the sub-character inside the Chinese character is dismantled according to the corner input sequence;
24. “D”: when a sub-character is surrounded by four adjacent sides of a sub-character, the symbol “D” is adopted and then the sub-character inside the Chinese character is dismantled according to the corner input sequence; and
25. “0”: when one of the line segments, turns or intersections of a corner in a character have been used by a previously selected corner or nothing is at the corner, the symbol “0” is used.
